(19) United States
(12) Patent Application Publication
(10) Pub. No.: US 2011/0031945 A1
(43) Pub. Date: Feb. 10, 2011

(54) THRESHOLD VOLTAGE EXTRACTION CIRCUIT

(75) Inventor: Jonah E. Nuttgens, Southampton (GB)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/988,033

(22) PCT Filed: Apr. 14, 2009
(86) PCT No.: PCT/IB2009/051548

§ 371 Date: Oct. 15, 2010

(30) Foreign Application Priority Data
Apr. 16, 2008 (EP) 08103568.5

(51) Int. Cl. G05F 1/10

(52) U.S. Cl. 323/265

(57) ABSTRACT

A pair of MOS transistors (10,12) are arranged as a potential divider. As the MOS transistors (10,12) pass from a weak inversion regime to a strong inversion regime, the voltage at the midpoint of the threshold divider changes from being substantially constant to varying. A difference amplifier (14) is used to detect this voltage, and a feedback loop (16) through a further transistor (18) is also provided.

The invention relates to a circuit and a method for determining the threshold voltage of a MOS transistor.

It is known to measure the threshold voltage of a field effect transistor (FET) in a circuit. An example of a circuit of this type is Wang, Z., “Automatic VT extractors based on an n×n² MOS transistor array and their application,” Solid-State Circuits, IEEE Journal of, vol. 27, no. 9, pp. 1277-1285, September 1992.

However, such circuits use significant power and current which is undesirable. In particular, such circuits may be unsuitable for incorporation into low power circuitry. Also, such circuits can take up a significant wafer area when integrated onto a CMOS integrated circuit which is undesirable.

In an aspect of the invention, there is provided a circuit for extracting a threshold voltage, including:

a potential divider formed from first and second MOS transistors having gates connected together, such that the MOS transistors change from a weak inversion regime to a strong inversion regime as the gate-source voltage crosses a threshold voltage, wherein the output voltage of the potential divider changes between a substantially constant value and a value that varies with the applied gate-source voltage as the gate-source voltage crosses the threshold voltage; and

a difference amplifier arranged to compare the voltage output from the potential divider with a reference voltage to detect the threshold voltage.

The circuit has a number of desirable characteristics. Firstly, the circuit uses only a limited amount of power—it can operate on fractions of a microampere. The first and second MOS transistors need not be fully turned on and so can operate with only very small currents.

The circuit does not require a large silicon area since it does not require any large resistors. Also, the circuit is floating and does not require either plus or minus node to be grounded. The circuit does not have any redundant stable states and hence requires no start-up circuit.

The circuit is compatible with any CMOS process, uses only standard enhancement mode MOS transistors, and does not require a triple-well process.

The circuit may further include a feedback loop driven by the output of the difference amplifier for driving the voltage between the plus voltage node and the minus voltage node towards the threshold voltage.

A possible embodiment is a simple two-terminal circuit, the plus and minus nodes acting as the terminals, which is functionally similar to a Zener diode with a breakdown voltage corresponding closely to the V_{T} of a MOS transistor. This makes the circuit easy to integrate into other circuits.

A Threshold Voltage Extractor circuit based on this concept has potential uses in many fields of CMOS circuit design, particularly in low-power applications where other methods of threshold voltage extraction are unsuitable. For example, it could be used to determine the optimum supply voltage for lowest-possible power operation of any piece of CMOS circuitry whose minimum supply voltage requirement is a function of threshold voltage V_{T}. It could also be used for reference voltage generation for threshold voltage compensation or optimum biasing of MOS circuitry; e.g. the charge pump that is used to generate the power supply of a Passive RFID Tag, in which MOS transistors are used as rectifiers and require correct biasing to minimise their forward voltage drop and reverse leakage current, for maximum efficiency and therefore Tag read range.

The extracted voltage tracks changes in the MOS threshold voltage V_{T} caused by temperature, process variations, and back-bias voltage. Although its ultimate accuracy is limited, the error in its output is nonetheless much smaller than the variance of the threshold voltage V_{T} itself. Therefore, when used for threshold voltage-compensation purposes, it can eliminate much of the unpredictability of the performance of any circuit whose behaviour would otherwise depend on threshold voltage.

The reference voltage may be set to be from 1% to 50% greater than the output of the divider in the weak-inversion region, so that the difference between the two voltages measured by the amplifier changes polarity at or near the point that the gate-source voltage of the MOS transistor pair crosses the MOS threshold voltage. In embodiments, the reference voltage is set to be from 5% to 20% greater than the output of the divider in the weak-inversion region.

In another aspect of the invention there is provided a circuit for extracting a threshold voltage, including:

a first MOS transistor of a first conductivity type connected in series with a second MOS transistor of the same conductivity type between a plus voltage node and a minus voltage node, the first and second MOS transistors having a central node between them, so that as the voltage between the plus node and the minus node rises towards the threshold voltage of the first and second MOS transistors the voltage on the central node has a plateau at a weak inversion voltage; and

a different amplifier for comparing the voltage on the central node with a reference voltage, wherein the reference voltage is from 1% to 50% higher than the weak inversion voltage.

For a better understanding of the invention, embodiments will now be described, purely by way of example, with reference to the accompanying drawings, in which:

FIG. 1 shows a conceptual diagram of a first embodiment of the invention;

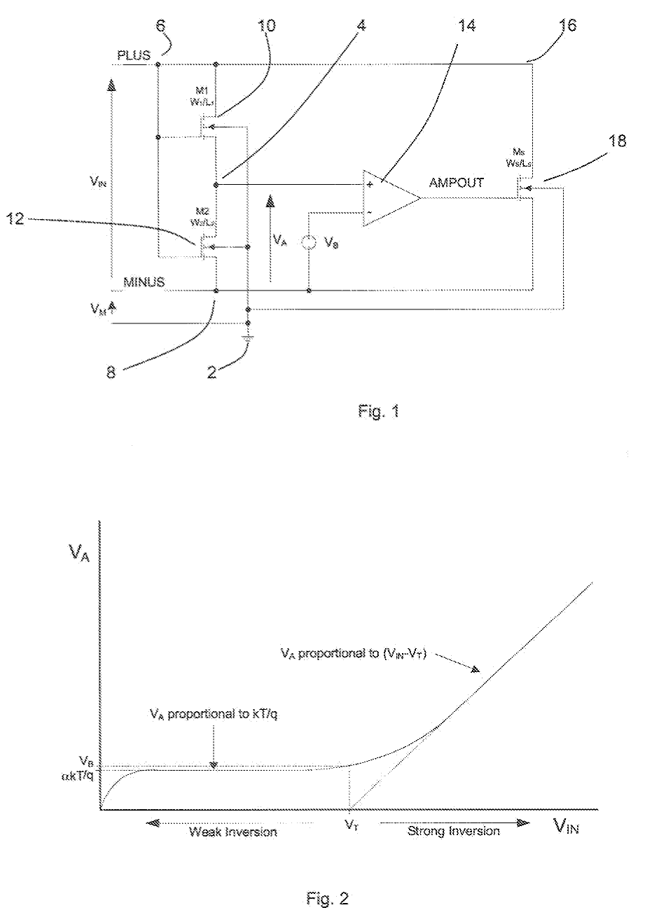

FIG. 2 illustrates the voltage transfer characteristics of part of the circuit of FIG. 1;

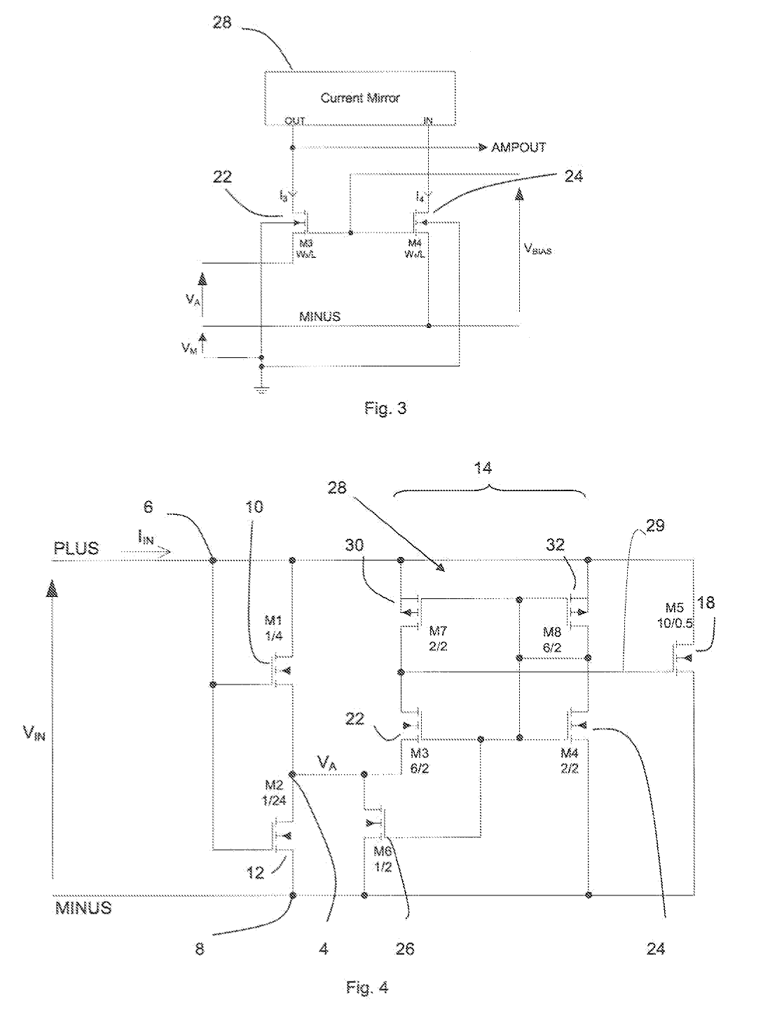

FIG. 3 shows an implementation of part of the circuit of FIG. 1;

FIG. 4 shows a second embodiment of the invention; and

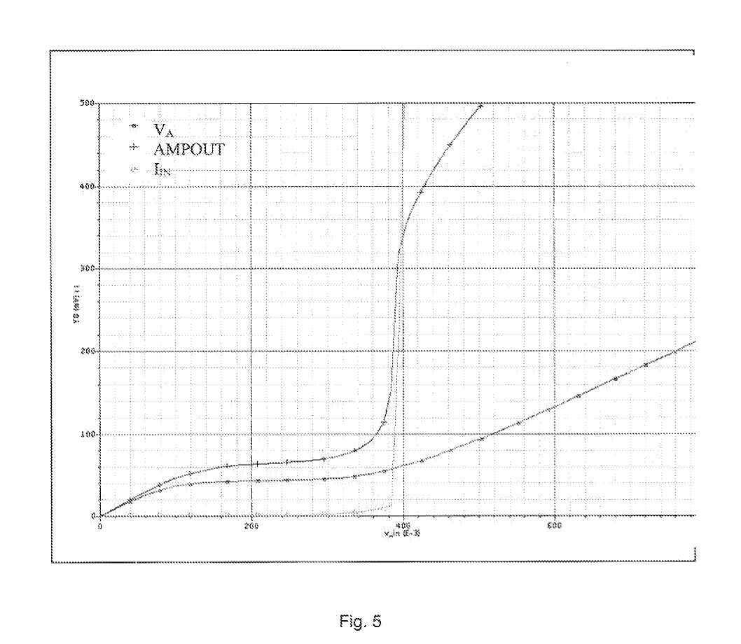

FIGS. 5 to 7 show simulation results of the embodiment of FIG. 4.

The drawings are schematic and not to scale.

FIG. 1 shows a conceptual diagram of a first embodiment of a circuit for V_{T}-extraction in the form of a two-terminal circuit that behaves similarly to a Zener diode.

Note in particular the first (M1) and second (M2) MOS transistors 10,12, in the embodiment enhancement mode NMOS. They are connected in series between a plus circuit input 6 and minus circuit input 8. The gates of the first and second circuit inputs are connected to the plus input 6. The central node 4 between the first and second transistors 10,12 is at output voltage V_{A}. Thus, the transistors 10,12 act as a potential divider with the central node 4 as the output.

The central node 4 is connected to a differential amplifier 14 which will be referred to as a difference amplifier in view of its function of comparing the output voltage V_{A} of the first and second MOS transistors 10, 12 with reference voltage V_{B} which is, to a reasonable approximation, proportional to absolute temperature.

A feedback loop 16, in this embodiment using a shunt transistor 18 completes a feedback loop from the difference amplifier 14 output to the circuit input, which tries to keep V_{IN} close to V_{T}.

Describing the circuit in more detail, the circuit consists of three sections: a voltage divider formed by the first and second MOS transistors 10,12; the op-amp 14 to compare V_{A} with reference voltage V_{B} and amplify the difference between them; and the shunt transistor 18.

A ground connection 2 shown in FIG. 1 is included only to illustrate the bulk node connection of the MOS transistors 10,12 and their source-bulk voltages defined by V_{M}, which are required for the analysis of the circuit.

The configuration of the first and second MOS transistors 10, 12 produces a voltage response V_{A} versus V_{IN} of the form shown in FIG. 2 (neglecting any loading by the op-amp input). The salient points of this transfer characteristic are the near-constant output voltage proportional to kT/q when the transistors are in the weak-inversion region (V_{IN}<V_{T}), which may be referred to as a plateau, and the distinct upturn in the output voltage that begins at around V_{IN}=V_{T}.

The shape of this voltage transfer characteristic can be derived from analysis of the divider in weak-inversion and strong-inversion regions, as will now be demonstrated.

First, let the sizes of the first and second MOS transistors be related by n, where W₁/L₁=nW₂/L₂. Now, in the weak-inversion region where V_{IN}<V_{T}, the drain current in each transistor can be found from the MOS sub-threshold equation:

$${I}_{D} = \frac{W}{L} {I}_{D 0} {e}^{\frac{{V}_{GB}}{{mU}_{T}}} ( {e}^{\frac{- {V}_{SB}}{{U}_{T}}} - {e}^{\frac{- {V}_{DB}}{{U}_{T}}} ) ,$$

where U_{T} is the thermal voltage kT/q.

So, for the first MOS transistor 10:

$$\begin{matrix}{I}_{D} = \frac{{nW}_{2}}{{L}_{2}} {I}_{D 0} {e}^{\frac{{V}_{IN} + {V}_{M}}{{mU}_{T}}} ( {e}^{\frac{- ( {V}_{A} + {V}_{M} )}{{U}_{T}}} - {e}^{\frac{- ( {V}_{IN} + {V}_{M} )}{{U}_{T}}} ) \\ = \frac{{nW}_{2}}{{L}_{2}} {I}_{D 0} {e}^{\frac{{V}_{IN} + {V}_{M}}{{mU}_{T}}} {e}^{\frac{- {V}_{M}}{{U}_{T}}} ( {e}^{\frac{- {V}_{A}}{{U}_{T}}} - {e}^{\frac{- {V}_{IN}}{{U}_{T}}} )\end{matrix}$$

Similarly for the second MOS transistor 12:

$$\begin{matrix}{I}_{D} = \frac{{W}_{2}}{{L}_{2}} {I}_{D 0} {e}^{\frac{{V}_{IN} + {V}_{M}}{{mU}_{T}}} ( {e}^{\frac{- {V}_{M}}{{U}_{T}}} - {e}^{\frac{- ( {V}_{A} + {V}_{M} )}{{U}_{T}}} ) \\ = \frac{{W}_{2}}{{L}_{2}} {I}_{D 0} {e}^{\frac{{V}_{IN} + {V}_{M}}{{mU}_{T}}} {e}^{\frac{- {V}_{M}}{{U}_{T}}} ( 1 - {e}^{{e}^{\frac{- {V}_{A}}{{U}_{T}}}} )\end{matrix}$$

Equating the drain current in the first and second MOS transistors 10,12 (neglecting the load of the op-amp input) and cancelling common terms gives:

$$n ( {e}^{\frac{- {V}_{A}}{{U}_{T}}} - {e}^{\frac{- {V}_{IN}}{{U}_{T}}} ) = 1 - {e}^{\frac{- {V}_{A}}{{U}_{T}}} \\ ( 1 + n ) {e}^{\frac{- {V}_{A}}{{U}_{T}}} = 1 + n {e}^{\frac{- {V}_{IN}}{{U}_{T}}}$$

Thus, the relationship between V_{A} and V_{IN} is dependent only on device geometry and temperature, and is independent of V_{M}. As V_{IN} increases beyond a few times U_{T}, the last exponential in the above equation becomes smaller and eventually negligible compared to 1. Therefore V_{A} also becomes almost independent of V_{IN}, and the curve flattens off with a value of approximately:

$${V}_{A} \approx {U}_{T} {log}_{e} ( 1 + n ) = \frac{kT}{q} {log}_{e} ( 1 + n )$$

Next, behaviour in strong-inversion is considered. The following analysis is valid when V_{IN} is greater than V_{T} by at least a few times U_{T}, such that both the first and second transistors are strongly inverted. In this condition, the first MOS transistor 10 is saturated (since V_{DS}=V_{GS}). For any current to flow in the first MOS transistor 10, its V_{GS} must be >V_{T}, and therefore the second transistor 12 operates in the triode region since its V_{DS} is more than a V_{T} below its V_{GS}.

So, for the first MOS transistor 10 in saturation (ignoring velocity saturation and channel length modulation effects):

$${I}_{D} = \frac{μ {C}_{ox}}{2} \frac{{nW}_{2}}{{L}_{2}} {( {V}_{IN} - {V}_{A} - {V}_{T} )}^{2}$$

For the second transistor 12 in the triode region:

$${I}_{D} = μ {C}_{ox} \frac{{W}_{2}}{{L}_{2}} ( {V}_{IN} - {V}_{T} - \frac{{V}_{A}}{2} ) {V}_{A}$$

Equating and eliminating common terms, assuming the threshold voltage V_{T} of the first and second transistors 10,12 to be equal:

$$\frac{n}{2} {( {V}_{IN} - {V}_{T} - {V}_{A} )}^{2} = ( {V}_{IN} - {V}_{T} - \frac{{V}_{A}}{2} ) {V}_{A}$$

Rearranging and collecting V_{A} terms gives:

$${V}_{A}^{2} - 2 ( {V}_{IN} - {V}_{T} ) {V}_{A} + \frac{{n ( {V}_{IN} - {V}_{T} )}^{2}}{n + 1} = 0$$

Solving the quadratic equation for V_{A} yields two possible solutions;

$${V}_{A} = ( {V}_{IN} - {V}_{T} ) ( 1 \pm \sqrt{1 - \frac{n}{n + 1}} )$$

Of these solutions, the “plus” option would result in the V_{GS} of the first transistor being less than the threshold voltage V_{T}, so it would violate the original conditions (that both devices are strongly inverted). Therefore the correct solution is:

$${V}_{A} = ( {V}_{IN} - {V}_{T} ) ( 1 - \sqrt{1 - \frac{n}{n + 1}} )$$

This result shows that, when V_{IN}>V_{T}, V_{A} is no longer constant but increases linearly with V_{IN}. In practice the slope is somewhat shallower than the equation suggests, due to effects that have been neglected in the above derivation; in particular, the variation of the V_{T} of the first transistor with V_{A} due to the body effect. However, the magnitude of the slope is not critical for analyzing the behaviour of the circuit; only the fact that the behaviour of V_{A} changes between the weak and strong inversion regions.

In the transition region where V_{IN}≈V_{T} (moderate inversion region), a full mathematical analysis of the circuit is much more difficult since the drain current of both transistors contains contributions from both drift and diffusion mechanisms; also, the threshold voltage transitions from weak to strong inversion slightly earlier than the first transistor due to its higher V_{GS}, and is also briefly saturated since its V_{DS} is higher than the strong-inversion equations would predict. However, for the purpose of qualitatively explaining the circuit's behaviour, it is sufficient to observe that it is in this transition region that V_{A} starts to rise noticeably above its sub-threshold plateau, and that is does so monotonically with increasing V_{IN}.

Having established a voltage transfer characteristic that exhibits a change in trend at around V_{T}, the next stage is to detect and amplify this transition. This is done by comparing V_{A} with a reference voltage V_{B}, which is set to be just higher than the sub-threshold plateau voltage of (kT/q)logₑ(1+n), as illustrated in FIG. 2.

FIG. 1 shows schematically the reference voltage is generated using a reference voltage circuit 20. However, in the embodiment the reference voltage V_{B} is in fact generated integrally with the amplifier 14 as will now be explained with reference to FIG. 3.

FIG. 3 shows a circuit functioning as reference voltage generator 20 and difference amplifier 14 of FIG. 1 using an asymmetrical MOS differential pair operating in the weak inversion region. Third and fourth NMOS transistors 22, 24 form a common-gate differential pair which is the basis of a single-stage op-amp, whose output is AMPOUT 29. The pair is fed from current mirror 28, having an input and output as shown.

One input of the amplifier 14 (at the source of fourth transistor 24) is tied to MINUS (the minus node 8) and the other (at the source of the third transistor 22) is connected to the central node 4 and hence voltage V_{A}. The asymmetry required to produce an input offset voltage can be applied either as a difference in width between the third and fourth transistors 22, 24, or as a ratio between currents I₃ and I₄, or both. V_{BIAS} is set at a value <V_{T} to ensure that M3 and M4 operate in the weak-inversion region.

In general, let the ratio between the widths of the third and fourth transistors 22,24 be x and the ratio between currents I₄ and I₃ be y, such that:

W₃=xW₄

I₄=yI₃

The input offset voltage of the amplifier, V_{B}, is the voltage on V_{A} at which the amplifier output is in equilibrium; so no current flows in AMPOUT and the amplifier output is not saturated. This is defined as being the point where the drain currents of the third and fourth transistors 22, 24 match the currents sourced by the mirror. At this point, the following equations for sub-threshold operation are satisfied:

$${I}_{3} = \frac{{W}_{3}}{L} {I}_{D 0} {e}^{\frac{{V}_{BIAS} + {V}_{M}}{{mU}_{T}}} ( {e}^{\frac{- ( {V}_{A} + {V}_{M} )}{{U}_{T}}} - {e}^{\frac{- {V}_{DB}}{{U}_{T}}} )$$

$${I}_{4} = {yI}_{3} = \frac{{W}_{4}}{L} {I}_{D 0} {e}^{\frac{{V}_{BIAS} + {V}_{M}}{{mU}_{T}}} ( {e}^{\frac{- {V}_{M}}{{U}_{T}}} - {e}^{\frac{- {V}_{DB}}{{U}_{T}}} )$$

Assuming that the drain-source voltages of both transistors are more than a few times U_{T}, then the last exponential in each equation becomes negligible. Therefore, removing these terms, substituting W₃=xW₄ and equating the two expressions through I₃ yields the following result:

$$xy \cdot {e}^{\frac{- ( {V}_{A} + {V}_{M} )}{{U}_{T}}} = {e}^{\frac{{V}_{M}}{{U}_{T}}}$$

$${e}^{\frac{{V}_{A}}{{U}_{T}}} = xy$$

$${V}_{B} = {V}_{A} = \frac{kT}{q} {log}_{e} ( xy )$$

This analysis shows that the input offset voltage V_{B} is proportional to kT/q and is controlled only by the ratios of device sizes and currents. It is independent of V_{M} and V_{BIAS}, provided that the latter is less than V_{T}. Therefore, to set the amplifier offset voltage V_{B} to detect the point at which V_{IN} exceeds V_{T}, the simple result is that xy must be set slightly higher than (1+n). In practice there must be sufficient margin between the values of xy and (1+n) to allow for the effects of random variance on component parameters.

The circuit operation described so far produces an output (AMPOUT) that directly indicates whether V_{IN} is greater than or less than V_{T}. This can be used as an output in its own right, and in that sense completes the explanation of the threshold voltage detection technique.

However, as already mentioned, a feedback loop can be used to obtain a reference voltage of V_{T}. The feedback loop feeds back the output AMPOUT to V_{IN}, such that equilibrium is attained when V_{IN} is equal to V_{T}, delivering a two-terminal device in which the plus and minus nodes act as the terminals.

In this embodiment, this feedback is implemented by the shunt transistor 16. Its gate is driven by the amplifier output, so that it resists any increase of V_{IN} above V_{T}. The only criterion for this transistor is that its aspect ratio Wₛ/Lₛ should be very much larger than that of M1 and M2; this ensures that it dominates the current flow from PLUS to MINUS when switched on.

So, to summarise the operation of the complete circuit: when V_{IN}<V_{T}, V_{A} is approximately (kT/q)logₑ(1+n). Provided that (1+n) is less than xy, then this value is lower than the reference voltage V_{B}, so the output of the op-amp is driven low. It saturates just above V_{A}, which is significantly lower than the threshold voltage of M_{S}, so this device is effectively switched off. Therefore the total current flow through the circuit is small.

As V_{IN} starts to exceed V_{T}, V_{A} increases above V_{B}. The amplifier output now swings high, approaching V_{IN} which is high enough to bring M_{S} into conduction. As this is a relatively wide, short-channelled device, its drain current is significantly larger than that drawn by the rest of the circuit. Thus the total current through the circuit increases sharply as V_{IN} rises further above V_{T}, making the circuit functionally similar to a Zener diode with a breakdown voltage of V_{T}.

The value of V_{M} has no net effect on the sub-threshold operation of the circuit, but does influence the value of V_{T} of all of the NMOS devices, and therefore the value of V_{IN} at which V_{A} starts to increase. Therefore the extracted voltage corresponds to the V_{T} of a transistor whose source terminal is at the same potential as the MINUS terminal of the circuit, or in other words, whose V_{SB} is equal to V_{M}.

The minimum current required for the extraction of V_{T} with this technique is very small, since all transistors in the circuit operate at or below the threshold of strong inversion. This is a fundamental difference to other V_{T}-extraction techniques, which typically derive V_{T} from transistor characteristics well inside the strong inversion (linear or saturated) regions.

Note that the above embodiment can be modified if required. For example, if the feedback loop is not required, it (and the shunt transistor 18) can be omitted.

Further, instead of the built-in input offset voltage of the difference amplifier 14, as illustrated in the example and described above with reference to FIG. 3, V_{B} may be a separate voltage source.

Also, whilst FIG. 1 shows NMOS transistors 10,12 as being NMOS devices, the technique is equally applicable to PMOS transistors, with appropriate sign reversal of voltages and currents.

FIG. 4 shows a further embodiment, an implementation of the invention in a 0.14 micron CMOS technology, in NMOS. Bulk connections are omitted from the diagram for simplicity. The circuit uses a Zener diode-like shunt regulator configuration.

In this implementation, the values of n, x and y are 6, 3 and 3 respectively; therefore the sub-threshold plateau voltage of V_{A} is logₑ 7×kT/q, and V_{B} is logₑ 9×kT/q. The current mirror for the asymmetric op-amp is formed by a pair of MOS transistors 30,32 (M7 and M8), which also provides a suitable bias voltage for the NMOS differential pair 22,24. The only addition to the basic architecture is additional MOS transistor 26, which ensures that loading of the op-amp stage always tries to pull V_{A} negative. Without this, the op-amp input current can dominate the behaviour of V_{A} at very low values of V_{IN}, which causes a hump in the circuit's I-V characteristic at low voltages.

FIG. 5 shows the simulation results of nodes V_{A}, AMPOUT and the current through the complete circuit I_{IN}, while sweeping V_{IN}, with V_{M} fixed at 0V (MINUS terminal at same potential as NMOS bulk). The threshold voltage V_{T} of a NMOS device in this process, with the same dimensions as the first transistor and with V_{SB}=0V, is 367 mV according to the simulation models used to generate these graphs. Due to the safety margin between V_{B} and the sub-threshold plateau of V_{A}, the value of V_{IN} at which the current starts to increase rapidly is slightly higher than this, at around 390 mV.

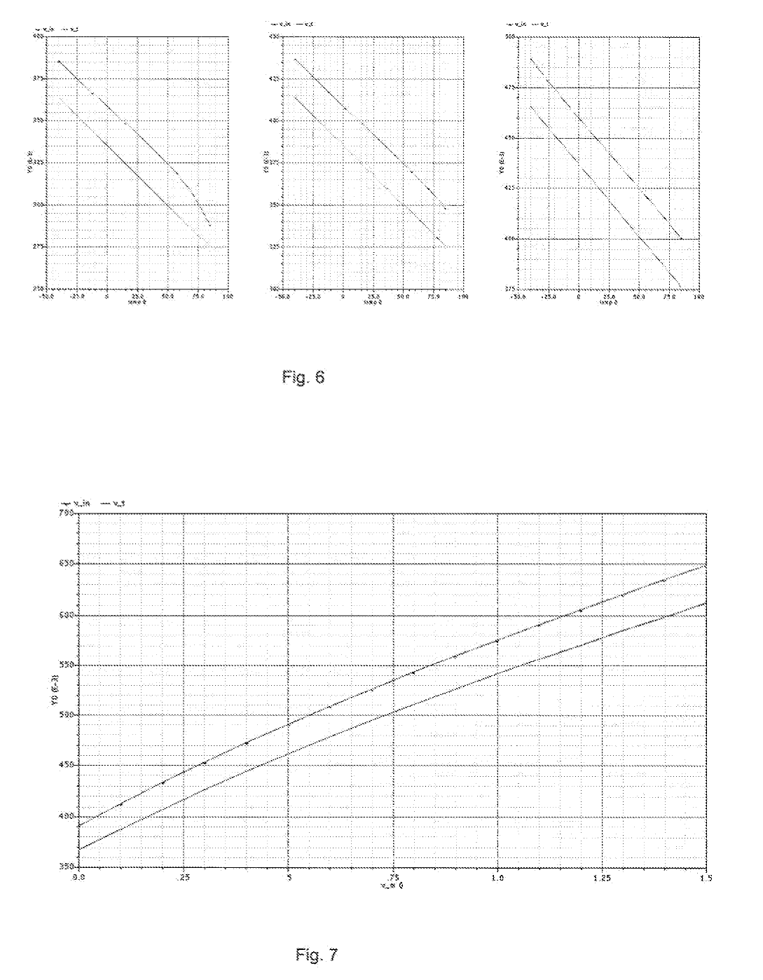

FIGS. 6 and 7 show the variation of the extracted V_{T} over temperature at fast, nominal and slow process corners, and with back-bias voltage V_{M} at nominal process, all with an input current of 100 nA (upper graph on each Figure). Both graphs also show the actual V_{T} of a NMOS device with the same dimensions as the first transistor (lower graph on each Figure), under the same process and temperature conditions and with V_{SB}=V_{M}. As can be seen, there is a systematic error between actual V_{T} and the extracted voltage, but this error stays reasonably constant over a wide range of conditions, typically between +5 and +7%.

The above embodiments are presented purely by way of example but those skilled in the art will realise that many variations are possible.

Note that in the present application the term “MOS” has been used in its general meaning referring generally to field effect transistors and is not intended to imply, for example, that the gate insulator has to be oxide or that the conducting regions cannot be polysilicon or other non-metal conductor.

1. A threshold voltage extraction circuit comprising:
a potential divider formed from first and second MOS transistors, the first and second MOS transistors having gates connected together, wherein the MOS transistors change from a weak inversion regime to a strong inversion regime as the gate-source voltage of the MOS transistors crosses a threshold voltage, wherein the output voltage of the potential divider changes between a substantially constant value and a value that varies with the applied gate-source voltage as the gate-source voltage crosses the threshold voltage; and
a difference amplifier arranged to compare the voltage output from the potential divider with a reference voltage to detect the threshold voltage of the MOS transistors.

2. A circuit according to claim 1, wherein the potential divider is connected between a plus voltage node and a minus voltage node, the gates of the first and second MOS transistors being connected to one of the plus voltage node and the minus voltage node, the circuit further comprising a feedback loop driven by the output of the difference amplifier for driving the voltage between the plus voltage node and the minus voltage node towards the threshold voltage.

3. A circuit according to claim 2 wherein the feedback loop includes a shunt transistor having its gate connected to the output of the difference amplifier, the shunt transistor being connected between the plus and minus voltage nodes.

4. A circuit according to claim 1, wherein
the potential divider is connected between a plus voltage node and a minus voltage node, with the output of the potential divider on a central node between the first and second transistors; and
the difference amplifier comprises:
an output;
a third MOS transistor connected in series between one terminal of a current mirror and the central node, the said one terminal being connected to the output;
a fourth MOS transistor connected in series between another terminal of the current mirror and one of the plus and minus voltage nodes,
wherein the gates of the third and fourth MOS transistors are connected together.

5. A circuit according to claim 4 further comprising a further MOS transistor connected between the same one of the plus and minus nodes as the fourth MOS transistor having its gate connected to the gates of the third and fourth MOS transistors.

6. A circuit according to claim 4, wherein
the aspect ratio of the first MOS transistor is a first ratio n times the aspect ratio of the second MOS transistor;
the width of the third MOS transistor is a second ratio x times the width of the fourth MOS transistor; and
the current output by the current mirror through the fourth MOS transistor is a third ratio y times the current output by the current mirror through the third MOS transistor; and
the product (xy) of the second and third ratios is between 1% and 50% greater than (1+n) wherein n is the first ratio.

7. A circuit according to claim 1 wherein the reference voltage is set to be from 1% to 50% greater than the output of the divider in the weak-inversion region, so that the difference between the two voltages measured by the amplifier changes polarity as the gate-source voltage of the MOS transistor pair crosses the MOS threshold voltage.

8. A circuit according to claim 1 wherein the difference amplifier is asymmetric such that the reference voltage is an inherent input offset voltage.

9. A circuit according to claim 1 wherein each of the said MOS transistors has the same conductivity type.

10. A circuit according to claim 9 wherein each of the said MOS transistors is n-type.

11. A method of extracting a threshold voltage, including:
providing a first MOS transistor of a first conductivity type connected in series with a second MOS transistor of the same conductivity type between a plus voltage node and a minus voltage node, the first and second MOS transistors having a central node between them, wherein as the voltage between the plus node and the minus node rises towards the threshold voltage of the first and second MOS transistors the voltage on the central node has a sub-threshold plateau; and
comparing the voltage on the central node with the reference voltage, wherein the reference voltage is from 1% to 50% higher than the sub-threshold plateau.

12. A method according to claim 11 further comprising feeding back the result of the step of comparing the voltage to the plus and/or minus voltage nodes to drive the voltage between the plus voltage node and the minus voltage node towards the threshold voltage.
